(19) United States
(12) Patent Application Publication
(10) Pub. No.: US 2015/0057917 A1
(43) Pub. Date: Feb. 26, 2015

(54) METHOD AND APPARATUS FOR POSITIONING AN UNMANNED VEHICLE IN PROXIMITY TO A PERSON OR AN OBJECT BASED JOINTLY ON PLACEMENT POLICIES AND PROBABILITY OF SUCCESSFUL PLACEMENT

(71) Applicant: MOTOROLA SOLUTIONS, INC., Schaumburg, IL (US)

(72) Inventor: YAN-MING CHENG, INVERNESS, IL (US)

(73) Assignee: MOTOROLA SOLUTIONS, INC., Schaumburg, IL (US)

(21) Appl. No.: 13/972,347

(22) Filed: Aug. 21, 2013

(51) Int. Cl. G08G 9/00

(52) U.S. Cl. CPC G08G 9/00
USPC 701/300

(57) ABSTRACT

Warping vectors of an image and audio are used to determine visual and verbal interaction effectiveness. A probability of successful placement of an unmanned vehicle is determined based on placement policies and the visual and verbal interaction effectiveness. A direction of movement is then determined that maximizes the probability of successful placement. Instructions are issued to move the unmanned vehicle towards the direction that maximizes the probability of successful placement.

### FIELD OF THE INVENTION

The present invention generally relates to positioning an unmanned vehicle in the proximity of a person or an object, and more particularly to positioning the unmanned vehicle in the proximity of the person or an object based jointly on placement policies and interaction effectiveness.

### BACKGROUND OF THE INVENTION

In the public safety, public service, retail, and enterprise areas, there are many routine and repetitive tasks. These tasks include such things as patrolling neighborhoods to spot suspicious activities, spotting traffic violations, checking parking meters for illegal parking, checking planogram compliance of goods on retail shelves, answering queries from shoppers, etc. With advanced artificial intelligence, machine learning, and robotics, some of these tasks may be undertaken by robots or unmanned vehicles.

A drawback with using a single unmanned vehicle to tackle multiple tasks is that the “interaction” between a person/object and the unmanned vehicle will often play out very differently based on the interaction goal that exists between the unmanned vehicle and the person/object. For example, simply placing an unmanned vehicle in front of a person may be acceptable when answering an inquiry from a shopper (e.g., a shopper asks for directions to a particular product), however, in other situations the placement of the unmanned vehicle in front of a person will be undesirable (e.g., viewing for shop lifters, etc.). Because of this, a need exists for a method and apparatus for placing an unmanned vehicle in the proximity of a person that leads to an effective interaction and that, in the same time, takes placement policies into consideration.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an unmanned vehicle.

FIG. 2 is a flow chart showing operation of the unmanned vehicle of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned needs, a method and apparatus for placing an unmanned vehicle in proximity to a person/object is described herein. Warping vectors of an image and audio are used to determine visual and verbal interaction effectiveness. A probability of successful placement of an unmanned vehicle is determined based on placement policies and the visual and verbal interaction effectiveness. A direction of movement is then determined that maximizes the probability of successful placement. Instructions are issued to move the unmanned vehicle towards the direction that maximizes the probability of successful placement.

More particularly, during operation, the unmanned vehicle is, firstly, given an interaction goal. This interaction goal could be, for example:
answering a shopper query;
reading a parking meter;
chasing a suspected bugle;
questioning a driver about a suspected violation;
roaming a store looking for shoplifters;
roaming the streets looking for suspected criminal activity.

The coarse location of the person/object to interact with is also given to the unmanned vehicle by the operator of the unmanned vehicle.

The unmanned vehicle will use the interaction goal to extract a set of placement policies. These placement policies may include:
a minimum/maximum distances to the person/object;
a minimum distance to surrounding people/objects;
a height range of the unmanned vehicle, the position relative to driver seat (if the person is in a vehicle);
an angle of approach to the person/object.
Etc.

Usually, there exists a physical area, which satisfies all of placement policies simultaneously based on the determined interaction goal. This area will be changing (dynamic) as people/objects move while the unmanned vehicle attempts to place itself to accomplish the interaction goal.

After acquiring the set of placement policies, the unmanned vehicle will then place itself at a fine position in relation to the person/object, satisfying all of placement policies simultaneously. During fine positioning, adjustments will be made based on maximizing a probability of successful placement. More particularly, while maximizing a probability of successful placement, a probabilistic model is used that generates a larger probability value when total interaction effectiveness (visual plus verbal interactive effectiveness) is improved and when all of placement policies are satisfied. The probabilistic model in one embodiment comprises a maximum entropy model, where the probability of successful placement as a function of position to a person/object is used.

Because both placement policies and total interaction effectiveness are taken into consideration when placing the unmanned vehicle in proximity to the person/object, the unmanned vehicle can better perform its interaction tasks in a socially-acceptable manner.

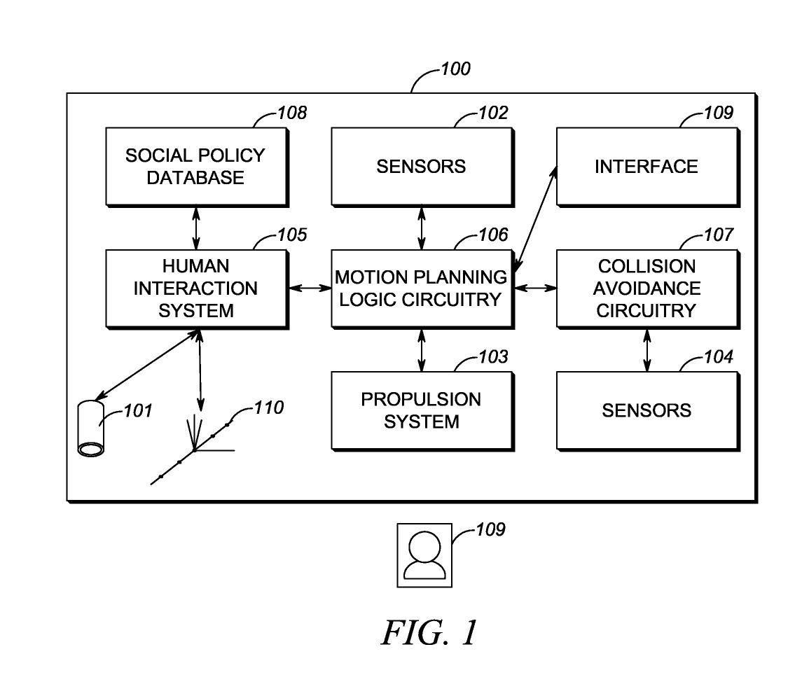

Turning now to the drawings, wherein like numerals designate like components, FIG. 1 is a block diagram of unmanned vehicle 100. Unmanned vehicle 100 may comprise an unmanned aerial vehicle (UAV), robot, or any computer that interacts with an object or person.

As shown, unmanned vehicle 100 comprises camera 101, microphone array 110, sensors 102, propulsion system 103, sensors 104, human interaction system/circuitry 105, motion planning logic circuitry 106, collision avoidance system 107, interface 109, and social policy database 108. Although shown as separate entities, the above systems, sensors, databases, and circuitry 101-107 may exist separately, or together in any number of memories, digital signal processors, general purpose microprocessors, programmable logic devices, or application specific integrated circuits that are programmed to perform their associated functions.

It should be noted that for simplicity and ease of understanding, only certain items were shown in FIG. 1. One of ordinary skill will recognize that vehicle 100 will comprise functionality not shown in FIG. 1. Although not shown, vehicle 100 may also comprise a graphical person interface (GUI) in order to appropriately interact with a person. GUI may include a video monitor, a keyboard, a mouse, and/or various other hardware components to provide a man/machine interface.

Sensors 102 and sensors 104 may comprise such sensors as a global positioning system (GPS) receiver, laser range finder, compass, altimeter, . . . , etc. These sensors are used by motion planning logic circuitry 106, and collision avoidance system 107 in order to determine the movement direction and the proper destination of vehicle 100.

Camera 101 and microphone array 110 may be used to generate warping vectors in order for human interaction system 105 to measure the effectiveness of the interaction from the vehicle 100 to a person/object.

Human interaction system 105 comprises (or is part of) a digital signal processors, general purpose microprocessors, programmable logic devices, or application specific integrated circuits that are programmed to use interaction metrics and placement policies to appropriately place vehicle 100 in the vicinity of person 109. More particularly, human interaction system is fed a current interaction goal (e.g., interacting with a customer, chasing a suspected bugler, questioning a driver about a suspected violation, . . . , etc.). The current interaction goal is used as index to retrieve a set of placement policies from database 108 in order to place vehicle 100.

Placement policy database 108 comprises standard random access memory and is used to store information related to the placement restrictions of vehicle 100 for each interaction goal encountered by vehicle 100. In one embodiment of the present invention database is indexed as shown in table 1.

TABLE 1
Interaction goal and Placement Policy

| | Placement policy based on |
|---|---|
| Interaction goal | interaction goal |
| Encountering a customer in a store | 1. At least, three feet from the |
| | customer; |
| | 2. At most, ten feet from the |
| | customer; |
| | 3. At least, one foot from any |
| | shelf; |
| | 4. At least, two feet from other |
| | shoppers; |
| | 5. Etc. |
| Providing a driver with a traffic | 1. At least, two feet directly to |
| ticket. | the left side of the driving |
| | vehicle; |
| | 2. At most, five feet away from |
| | the driver; |
| | 3. Higher than the bottom |
| | borderline of driver side |
| | window; |
| | 4. Lower than the top borderline |
| | of the driver side window; |
| | 5. Approaching the fine position |
| | from the rear and left sides of |
| | the vehicle; |
| | 6. Etc. |
| Signaling stop and pullover to a | 1. At least, five feet from rear |
| moving vehicle | window of the vehicle; |
| | 2. At most, twenty feet from the |
| | rear window; |
| | 3. The unmanned vehicle can |
| | see the driver seat from the |
| | rear window of the moving |
| | vehicle; |
| | 4. Approaching the moving |
| | vehicle from rear side; |
| | 5. Etc. |
| Reading roadside parking meters | 1. At least, one foot from the |
| | parking meter; |
| | 2. At most, two feet from the |
| | meter; |
| | 3. At least, three feet from any |
| | pedestrian. |
| | 4. Etc. |

Similar to human interaction system 105, motion planning logic circuitry 106 comprises (or is part of) a digital signal processors, general purpose microprocessors, programmable logic devices, or application specific integrated circuits that are programmed to position vehicle 100, and provide human interaction system 105 with a current position reading and sensor reading. More particularly, motion planning logic circuitry 106 is able to issue motion instructions to propulsion system 103, based on sensor readings, motion instruction issued by human interaction system 105, motion correction provided by collision avoidance circuitry 107 and coarse location of the interaction person/object given by an operator of the unmanned vehicle. When executing a task, motion planning logic circuitry 106 may continuously provide current location information to human interaction system 105.

Interface 109 may comprise common circuitry known in the art for communication utilizing a well known communication protocols. Such circuitry may comprise standard wireless transmission and receiving circuitry to transmit and receive messages/video to a centralized server and/or user.

Finally, collision avoidance circuitry 107 utilizes sensors 104 to avoid collisions with objects and people. Circuitry 107 comprises (or is part of) a digital signal processors, general purpose microprocessors, programmable logic devices, or application specific integrated circuits that are programmed to detect and avoid collisions with objects and individuals.

Human interaction system 105, motion planning logic circuitry 106, and collision avoidance system 107 are used to make motion adjustments to properly position vehicle 100. More particularly, appropriate motion instructions are sent to propulsion system 103 through motion planning logic circuitry 106 in order to properly position vehicle 100. In doing so, collision avoidance system 107 takes precedence and may override any instructions from human interaction system 105. Thus, during operation, motion planning logic circuitry 106 will instruct propulsion system 103 to execute a particular route through an area as part of the execution of a task. At the coarse location of the task provided by the operator of the unmanned vehicle, human interaction system 105 will use camera 101 and microphone array 110 to search a person/object to interact with. If the interaction person/object is determined, human interaction system 105 and collision avoidance circuitry will drive logic circuitry 106 to properly place the vehicle in relation to person 109.

### Properly Positioning by Human Interaction System

As discussed, both placement policies and probability of successful placement are used to properly position vehicle 100. It is the job of human interaction system 105 to do this. During operation human interaction system 105 will first determine an interaction goal. Although not necessary, in one embodiment of the present invention the interaction goal is provided by the operator of the unmanned vehicle via interface 109. System 105 will access database 108 and determine a set of placement policies based on the interaction goal

Now that the placement policies are known, a placement function per policy is required to determine whether the policy is satisfied at the current location. There are many types of placement functions that can be used for this purpose, but will be described herein using a Boolean placement function for each placement policy:

$${f}_{P} ( X ) = \{ \begin{matrix}True & if X satisfies P \\ False & otherwise\end{matrix} \\ where P is the policy and \\ X is the vector of current location and orientation of the vehicle . \qquad ( 1 )$$

In the above equation for example, a placement policy, “at least two feet from the customer”, can be expressed as a Boolean placement function that it is true and false if the unmanned vehicle is outside and inside of a two-feet radius circle centered at the customer, respectively.

In order to determine total interaction effectiveness, both a visual interaction effectiveness and a verbal (audio) interaction effectiveness are used. Visual interaction effectiveness is determined by system 105 by measuring image fuzziness (based on SNR) and/or a warping vector of the person's/object's face. This is described in detail later. Verbal interaction effectiveness is determined by system 105 by measuring voice SNR (signal to noise ratio) and/or measuring a directional warping vector of the person's voice. This is described in detail later.

Next, a probability of successful placement is determined as a function of verbal interaction effectiveness, visual interaction effectiveness and the whether the placement policies are satisfied (i.e., the value of the placement function ƒ_{P}(X)). More particularly, verbal interaction effectiveness, visual interaction effectiveness and ƒ_{P}(X) are inserted into a probabilistic model, for example, a maximum entropy model, by human-interaction system 105 in order to estimate the probability of successful placement. Furthermore, the gradient of the probabilistic model with respect to the location and orientation of unmanned vehicle relative to the person/object is used to estimate the direction of the unmanned vehicle movement which maximizes the probability of successful placement. This is described in detail below.

Human interaction system 105 will generate the direction of movement and provide this to motion planning logic circuitry 106. In return, human interaction system 105 will receive a new sensors reading from motion planning logic circuitry 106 about new location of the unmanned vehicle after the movement instructions been executed. Then, system 105 and circuitry 106 will repeat the above steps until the interaction goal is completed.

Determining a Fuzziness and a Warping Vector of a Person's/Object's Face:

The determination of the fuzziness of a person's/object's face from image captured in a camera is well-established art. Well-known steps are used in this embodiment. The step of determining a warping vector of a person/object is accomplished by first computing a grid, which connects the important points on, for example, a face, eyes, nose, lip, etc. Next, the warping of the grid is computed with respect to a symmetric grid. The larger the warping, the lower the visual interaction effectiveness.

### Determining SNR and a Warping Vector of a Person's Voice:

The determination of SNR of a person's voice from audio recorded by a microphone array is well-established art. Well-known steps are used in this embodiment. The step of determining a warping vector of a person's voice is accomplished by computing TOA (time-of-arrival) delays of acoustic waves of the person's voice arriving at each microphone in a microphone array (relative to the wave arriving to the central microphone in the array). The warping of TOA delay pattern of the microphone array with respect to a symmetric TOA delay pattern is determined. The larger the warping, the lower the verbal interaction effectiveness.

### The Probabilistic Model Used to Determine the Probability of Successful Placement

A probabilistic model, which generates larger probability value when total interaction effectiveness is improved and when all of placement policies are satisfied, may be used. One embodiment of the probabilistic model is a maximum entropy model, where the probability of successful placement given a location relative to the interaction person/object is:

$$\begin{matrix}P ( I / X ) ∝ \frac{1}{Z ( {λ}_{1} , ... , {λ}_{m} )} exp ( {λ}_{1} {f}_{1} ( X ) + … + {λ}_{m} {f}_{m} ( X ) ) , and & ( 2 ) \\ Z ( {λ}_{1} , … , {λ}_{m} ) = \int exp ( {λ}_{1} {f}_{1} ( X ) + … + {λ}_{m} {f}_{m} ( X ) ) d X , & ( 3 )\end{matrix}$$

where Z is normalization factor to ensure that the sum of all probabilities is one, I is successful placement and X is the current location and orientation coordinates of the unmanned vehicle relative to the interaction person/object. ƒ₁(X) . . . ƒₘ(X) are audio/visual interaction effectiveness measures and satisfaction functions of placement policies. λ₁ . . . λₘ, are the parameters of the maximum entropy model, and they need to be machine-learned with the presence of collected data in order to maximize the usefulness of the model. A gradient of the log probability of successful placement with respect to X, which indicates the improvement (or deterioration) of the probability at any direction, may also be computed as:

$$\frac{\partial }{\partial X} log ( P ( I / X ) ) = {λ}_{1} \frac{\partial }{\partial X} {f}_{1} ( X ) + … + {λ}_{m} \frac{\partial }{\partial X} {f}_{m} ( X ) \qquad ( 4 )$$

### Positioning the Unmanned Vehicle Based on the Probability of Successful Placement and Placement Policies

As soon as the person/object is detected by the sensors of the unmanned vehicle, human interaction system 105 will repeat the following steps:
Determine placement policies based on the goal.
Human interaction system 105 computes the location/orientation coordinates (location and orientation coordinates of the unmanned vehicle relative to the interaction person/object).
Determine one placement function per placement policy (ƒ_{P}(X)).
Determine visual and verbal interaction effectiveness.
Determine the probability of successful placement based on the placement functions and the visual and verbal interaction effectiveness.
Determine a direction of movement, which maximizes the probability of successful placement.
Issue instructions to motion planning circuitry 106 in order to move the unmanned vehicle towards the direction to maximize the probability of successful placement.
Vehicle 100 will return to the second step above after the movement instruction been executed. This process will be repeated until the completion of the goal, even though the person/object moves and/or surrounding environment evolves.

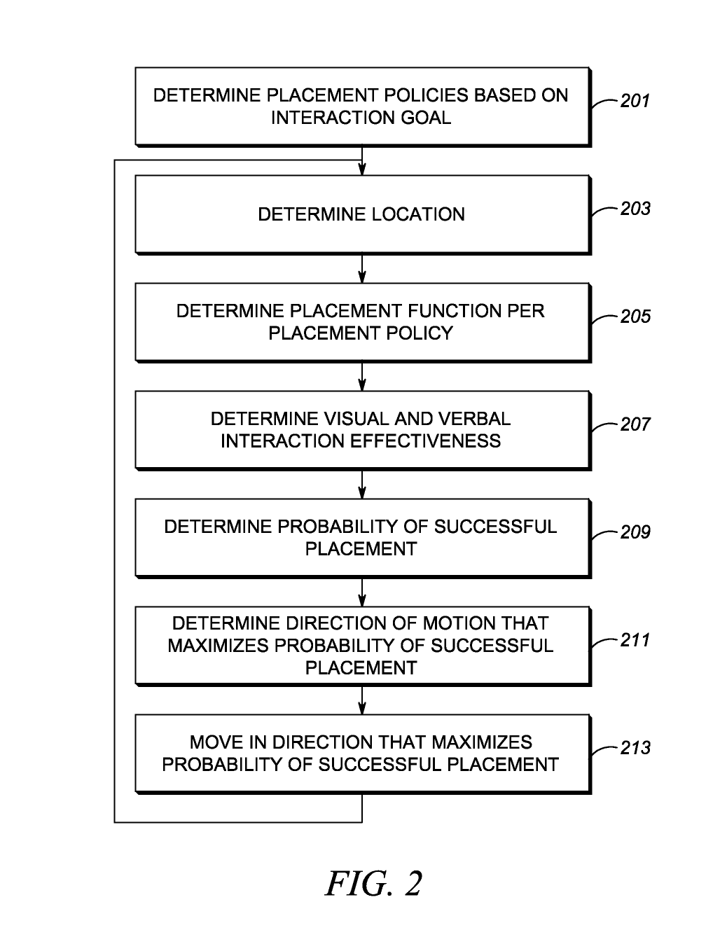

FIG. 2 is a flow chart showing operation of human interaction system 105. The logic flow of FIG. 2 assumes that an interaction goal has been received and/or determined by interface 109. The logic flow begins at step 201 where system 105 determines placement policies based on the interaction goal. As discussed above, this occurs by system 105 accessing database 108 to determine the placement policies for the particular interaction goal. At step 203 interaction system 105 will determine its location (unmanned vehicle location) with respect to the person/object of interest using the appropriate sensors. A single placement function (ƒ_{P}(X)) is determined and used for determining if each placement policy is satisfied (step 205). As discussed above, a Boolean placement function is used that it is true and false based on whether or not the placement policy is satisfied.

The logic flow then continues to step 207 where the visual and verbal interaction effectiveness are determined. As discussed above, this step comprises determining a visual and audio warping of the person or object. by determining a warping vector of the person or object and a directional warping vector, respectively. At step 209 a probability of successful placement is determined based on the placement functions and the visual and verbal warping (interaction effectiveness). More particularly, as shown in equations (2) and (3), a probabilistic model is used for the probability of successful placement, which generates larger probability value when both visual and audio interaction effectiveness are improved and when all of placement policies are satisfied.

After determining a probability of successful placement, a direction of movement is determined by system 105 that maximizes the probability of successful placement (step 211) and instructions are issued to motion planning circuitry 106 to move the unmanned vehicle towards the direction that maximizes the probability of successful placement (step 213). The logic flow then returns to step 203 after movement of the vehicle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for placing an unmanned vehicle in relation to a person or object, the method comprising the steps of:
determining an interaction goal;
determining placement policies based on the interaction goal;
determining a location of the unmanned vehicle;
determining if the placement policies are satisfied;
determining a visual and/or an audio warping of the person or object, wherein the visual warping is determined by computing a grid, which connects eyes, nose, and lisps and comparing the grid to a symmetric grid, and wherein the audio warping is determined by computing time-of-arrival delays of acoustic waves of a person's voice arriving at a microphone array;
determining a probability of successful placement, wherein the probability of successful placement is based on if the placement policies are satisfied, the visual warping of the person or object, and the audio warping of the person;
determining a direction of movement that maximizes the probability of successful placement; and
placing the unmanned vehicle in relation to the person or object based on maximizing the probability of successful placement.

2. The method of claim 1 wherein the interaction goal comprises a goal taken from the group consisting of:
answering a shopper query;
reading a parking meter;
chasing a suspected burglar;
questioning a driver about a suspected violation;
roaming a store looking for shoplifters; and
roaming the streets looking for suspected criminal activity.

3. The method of claim 1 wherein the placement policies are taken from the group consisting of:
a minimum/maximum distances to the person/object;
a minimum distance to surrounding people/objects;
a height range of the unmanned vehicle, the position relative to driver seat (if the person is in a vehicle); and
an angle of approach to the person/object.

4. The method of claim 1 wherein step of determining the visual warping of the person or object comprises the steps of determining a warping vector of the person or object.

5. The method of claim 1 wherein the step of determining the audio warping comprises the step of determining a directional warping vector.

6. The method of claim 1 wherein the step of determining the probability of successful placement comprises the step of determining a probability by using a maximum entropy model.

7. The method of claim 6 wherein the probability comprises:
$$\begin{matrix}P ( I / X ) ∝ \frac{1}{Z ( {λ}_{1} , ... , {λ}_{m} )} exp ( {λ}_{1} {f}_{1} ( X ) + … + {λ}_{m} {f}_{m} ( X ) ) , and \\ Z ( {λ}_{1} , … , {λ}_{m} ) = \int exp ( {λ}_{1} {f}_{1} ( X ) + … + {λ}_{m} {f}_{m} ( X ) ) d X ,\end{matrix}$$
where I is successful placement and X is the current location and orientation coordinates of the unmanned vehicle relative to the interaction person/object, ƒ₁(X) . . . ƒₘ(X) are audio/visual interaction effectiveness measures and satisfaction functions of placement policies, λ₁ . . . λₘ are the parameters of the maximum entropy model, and Z is a normalization factor to ensure the sum of all probability is one.

8. The method of claim 7 wherein the step of determining the direction of movement that maximizes the probability of successful placement comprises the step of determining a gradient of the log probability of successful placement P(I/X) with respect to X, that indicates the improvement (or deterioration) of the probability.

9. An apparatus comprising:
a database containing placement policies based on an interaction goal;
human interaction circuitry performing method for placing an unmanned vehicle in relation to a person or object, the human interaction circuitry accessing the database to determine placement policies, determining a location of the unmanned vehicle, determining if the placement policies are satisfied, determining a visual and/or audio warping of the person or object, determining a probability of successful placement, wherein the probability of successful placement is based on if the placement policies are satisfied, the visual warping of the person or object, and the audio warping of the person, determining a direction of movement that maximizes the probability of successful placement, and placing the unmanned vehicle in relation to the person or object based on maximizing the probability of successful placement; wherein the visual warping is determined by computing a grid, which connects eyes, nose, and lips and comparing the grid to a symmetric grid, and wherein the audio warping is determined by computing time-of-arrival delays of acoustic waves of a person's voice arriving at a microphone array.

10. The apparatus of claim 9 wherein the interaction goal comprises a goal taken from the group consisting of:
answering a shopper query;
reading a parking meter;
chasing a suspected burglar;
questioning a driver about a suspected violation;
roaming a store looking for shoplifters; and
roaming the streets looking for suspected criminal activity.

11. The apparatus of claim 9 wherein the placement policies are taken from the group consisting of:
a minimum/maximum distances to the person/object;
a minimum distance to surrounding people/objects;
a height range of the unmanned vehicle, the position relative to driver seat (if the person is in a vehicle); and
an angle of approach to the person/object.

12. The apparatus of claim 9 wherein the human interaction system determines the visual warping of the person or object by determining a warping vector of the person or object.

13. The apparatus of claim 9 wherein the human interaction system determines the audio warping by determining a directional warping vector.

14. The apparatus of claim 9 wherein the human interaction system determines the probability of successful placement by determining a probability using a maximum entropy model.

15. The apparatus of claim 14 wherein the probability comprises:
$$\begin{matrix}P ( I / X ) ∝ \frac{1}{Z ( {λ}_{1} , ... , {λ}_{m} )} exp ( {λ}_{1} {f}_{1} ( X ) + … + {λ}_{m} {f}_{m} ( X ) ) , and \\ Z ( {λ}_{1} , … , {λ}_{m} ) = \int exp ( {λ}_{1} {f}_{1} ( X ) + … + {λ}_{m} {f}_{m} ( X ) ) d X ,\end{matrix}$$
where I is successful placement and X is the current location and orientation coordinates of the unmanned vehicle relative to the interaction person/object, ƒ₁(X) . . . ƒₘ(X) are audio/visual interaction effectiveness measures and satisfaction functions of placement policies, λ₁ . . . λₘ are the parameters of the maximum entropy model, and Z is a normalization factor to ensure the sum of all probability is one.
